(19) United States
(12) Patent Application Publication
(10) Pub. No.: US 2026/0287947 A1
(43) Pub. Date: Sep. 24, 2026

(54) ELECTRONIC OPTICAL DEVICE FOR CONTROLLING LIGHT TRANSMISSION AND REFLECTION

(71) Applicant: ALPHAMICRON INCORPORATED, Kent, OH (US)

(72) Inventors: Roy Miller, Stow, OH (US); Bahman Taheri, Shaker Heights, OH (US)

(73) Assignee: ALPHAMICRON INCORPORATED, Kent, OH (US)

(21) Appl. No.: 19/474,412

(22) PCT Filed: Apr. 9, 2024
(86) PCT No.: PCT/US2024/023653

§ 371 Date: Oct. 10, 2025

Related U.S. Application Data
(60) Provisional application No. 63/458,766, filed on Apr. 12, 2023.

(51) Int. Cl. G02F 1/1335; G02F 1/137

(52) U.S. Cl. CPC G02F 1/133536; G02F 1/133509; G02F 1/13725

(57) ABSTRACT

An electronic optical device includes a first active absorptive polarizer that electronically alters absorption of a first polarization of light depending on an applied first voltage, and a second active absorptive polarizer that electronically alters absorption of a second polarization of light depending on an applied second voltage, wherein the second polarization is substantially orthogonal to the first polarization. A static reflective polarizer is interposed between the first active absorptive polarizer and the second active absorptive polarizer, wherein the static reflective polarizer reflects the first polarization of light. The electronic optical device can switch between a transmissive device state, a dark device state, a reflective device state, and a hybrid transmissive-reflective device state. One or both of the active absorptive polarizers may optionally be patterned into segments.

### CROSS-REFERENCE TO RELATED APPLICATIONS

This application claims priority to, and any other benefit of, U.S. Provisional Patent Application Ser. No. 63/458,766, entitled ELECTRONIC OPTICAL DEVICE FOR CONTROLLING LIGHT TRANSMISSION AND REFLECTION, filed Apr. 12, 2023, the entire disclosure of which is fully incorporated herein by reference.

### TECHNICAL FIELD

Embodiments of the subject matter disclosed herein relate to systems and methods using an electronic optical device for controlling the transmission or reflection of incident radiation, and in particular, to controlling light transmission or reflection of a window, a windshield, a sunroof, eyewear, or other systems intended for viewing through.

### BACKGROUND

In many situations, it is useful to control the intensity of light transmitted through or reflected off of a window, a windshield, eyewear, or other systems through which a person (or an imaging device) may wish to look. For example, a common issue is driving in bright sunlight. This may require the driver to find and put on sunglasses, move/adjust a car visor, or alternatively try their best to see under reduced safety viewing conditions (high glare, eye fatigue, eye discomfort, reduced contrast, inability to see onboard displays . . . etc.). Wearing sunglasses may help with the bright sun but may interfere with viewing dashboard information or heads-up displays. Car visors have limited areal coverage. Electronically dimmable windows are known, and can be useful, but may also interfere with heads up displays and are generally controlled as a unit. Dimming the entire window to make the bright sunlight acceptable may cause other parts of the scene to be darker than desired. In some cases, when a user is not driving, they may want much higher darkness than conventional dimming windows can provide or other increased functionality. In some situations, police, military or aviation personnel may be in situations where they may be subjected to harmful laser light intended to dazzle or blind them. Conventional dimming windows or eyewear are not able to handle this. Although some of the issues have been discussed in the context of windows and windshields, other systems can have similar problems.

Thus, a need exists for electronically controlled optical devices that have improved functionality with respect to managing light that may be incident on a system.

### SUMMARY

An electronic optical device includes a first active absorptive polarizer that electronically alters absorption of a first polarization of light depending on an applied first voltage, and a second active absorptive polarizer that electronically alters absorption of a second polarization of light depending on an applied second voltage, wherein the second polarization is substantially orthogonal to the first polarization. A static reflective polarizer is interposed between the first active absorptive polarizer and the second active absorptive polarizer, wherein the static reflective polarizer reflects the first polarization of light. The electronic optical device can switch between a transmissive device state, a dark device state, a reflective device state, and a hybrid transmissive-reflective device state. One or both of the active absorptive polarizers may optionally be patterned into segments.

These and other objects of this invention will be evident when viewed in light of the drawings, detailed description, and appended claims.

### BRIEF DESCRIPTION OF THE DRAWINGS

Reference is made to the accompanying drawings in which particular embodiments and further benefits of the provided subject matter are illustrated as described in more detail in the description below.

FIGS. 1A-1D are non-limiting examples of cross-sectional schematics of an electronic optical device in various device states according to some embodiments.

FIGS. 2A and 2B are non-limiting examples of cross-sectional schematics of an electronic optical device in different device states according to some embodiments.

FIG. 3 is a plan view of a non-limiting example of a patterned second active absorptive polarizer according to some embodiments.

FIG. 4 is a plan view of a non-limiting example of a graduated active absorptive polarizer according to some embodiments.

FIG. 5 is a cross-sectional view of a non-limiting example of an active absorptive polarizer according to some embodiments.

### DETAILED DESCRIPTION

### Definitions

Unless specifically defined otherwise herein, the definitions for optical parameters such as linear, circular, and unpolarized light are the same as those in Principles of Optics Electromagnetic Theory of Propagation, Interference and Diffraction of Light, Max Born, et al., Cambridge University Press; 7th edition (Oct. 13, 1999). Similarly, all liquid crystal terminology which is not specifically defined herein is to have the definition as used in Liquid Crystals Applications and Uses, vol. 3, edited by B. Bahadur, published by World Scientific Publishing Co. Pte. Ltd., 1992 (“Bahadur”).

An “absorptive polarizer” is a polarizer that will absorb a selected polarization of light. An absorptive polarizer will have two axes, an absorptive axis and a transmissive axis, which are at right angles to each other. The polarization of the light that is parallel to the absorptive axis is absorbed more than the polarization parallel to the transmissive axis.

For example, an “absorptive polarizer with an axis in the x-direction” means that the polarizer will substantially absorb the x-direction polarization of light while substantially allowing y-polarization to propagate. Vice versa, an absorptive polarizer with an axis in the y-direction means that the polarizer will substantially selectively absorb y-polarized light and substantially transmit x-polarized light.

It should be noted that absorptive circular polarizers exist and are typically constructed by using a linear polarizer in combination with a quarter wave retarder. Once light is polarized by the polarizer, the quarter wave plate induces a π/2 phase retardation which turns a linear polarization to a circular polarization.

An “active” polarizer, used interchangeably with an “active absorptive polarizer”, refers to a polarizer that will alter its absorption of the selected polarization of light depending on the applied voltage.

A controller coupled with the active polarizer controls the polarization. In some embodiments, the polarizer is operated in an ON or OFF state. In other embodiments, the polarizer can be set to apply a variable polarization absorption level with the controller setting a selected polarization level. In some examples, the polarization level of the active absorptive polarizer is selected by controlling the voltage applied to the active absorptive polarizer. Thus, the device can further include a controller for application of voltage to the device and the controller is coupled with the active absorptive polarizer.

The reflectivity and/or transmissivity of the devices can be controlled automatically, manually, or with a combination of both automatic and manual controls.

A “reflective polarizer” is a polarizer that will reflect a selected polarization of light more than the other. For example, a “reflective polarizer with a reflective axis in the x-direction” means that the reflective polarizer will reflect the x-direction polarization of incident light more than the other y-direction polarization. Vice versa, a “reflective polarizer with a reflective axis in the y-direction” means that the reflective polarizer will reflect the y-direction polarization of incident light more than the other x-direction polarization.

A “passive” or “static” reflective polarizer will always have the same reflective properties, whether voltage is applied to the device or not.

A “high absorbance state” refers to when the active absorptive polarizer is at or near its minimally transmissive state with respect to its light absorption profile (e.g., based on selection of the dichroic light absorbing materials, and which may be narrow band or wide band absorption) and polarization. In some embodiments, a high absorbance state may have a light transmission of less than 25%, 10%, 5%, 1%, 0.5%, 0.1%, 0.01%, or even 0.001% with respect to its light absorption profile and polarization. In some cases, a high absorbance state may, with respect to its light absorption profile and polarization, have a transmission in a range of 0.0001-0.001%, 0.001-0.01%, 0.01-0.1%, 0.1-0.5%, 0.5-1%, 1-5%, 5-10%, 10-15%, 15-20%, 20-25%, or any combination of ranges thereof.

A “low absorbance state” refers to when the active absorptive polarizer is at or near its maximally transmissive state with respect to its light absorption profile and polarization. In some embodiments, a low absorbance state may have a light transmission that is at least 20% higher than its corresponding high absorbance state. In some cases, a low absorbance state may have a light transmission of at least 10%, 15%, 20%, 25%, 30%, 35%, 40%, 45%, 50%, 55%, 60%, 65%, 70%, 75%, 85%, or 90%. In some cases, a low absorbance state may, with respect to its light absorption profile and polarization, have a transmission in a range of 10-15%, 15-20%, 20-25%, 25-30%, 30-35%, 35-40%, 40-45%, 45-50%, 50-55%, 55-60%, 60-65%, 65-70%, 70-75%, 75-80%, 80-85%, 85-90%, 90-95%, 95-97%, 97-99%, or any combination of ranges thereof.

A “narrow band” absorption profile refers to an absorbance spectrum characterized by a full-width, half-max of less than 175 nm, e.g., when measured in a range of 400-700 nm, or alternatively within 400-1000 nm, with respect to its intended polarization. Narrow band absorption profiles may impart a hue or color to the transmitted light.

A “wide band” or “broadband” absorption profile refers to an absorbance spectrum characterized by a full-width, half-max equal to or greater than 175 nm, e.g., when measured in a range of 400-700 nm, or alternatively within 400-1000 nm, with respect to its intended polarization. In some cases, wide band absorption profiles may be substantially neutral in color, but in some other cases, they may instead impart a hue or color to the transmitted light.

The terms P1 and P2 polarization, or “x” and “y” direction polarization, are arbitrary and refer to a first and second orthogonal linear or circular polarization direction of light which are at right angles to each other. They are used only to simplify the description of the present disclosure and do not refer to any fixed values of direction. In some cases, the term “substantially orthogonal” may refer to linear or circular polarization directions that are within 15° of orthogonal, alternatively within 10°, 5°, 3°, 2°, or 1°.

Conventionally, properties of a light are characterized by its (i) propagation direction, denoted by the wave vector, K, (ii) wavelength denoted by λ, (iii) two orthogonal polarizations direction, P1 and P2, (iv) polarization mode, which can be unpolarized, circular/elliptical or linear, and (iv) by energy being carried within each polarization, denoted here by I₁ and I₂. Generally, the term polarization refers to the oscillation direction of the electric field of the incident light. The difference between linear, circular and unpolarized light is in how a unique representation of the polarization is determined. In particular, in linearly polarized systems, the oscillation occurs in a single axis direction, x or y. In circularly polarized light, the oscillation rotates in time or space tracing out a circle or ellipse. In unpolarized light, the oscillation direction cannot be uniquely defined. Unpolarized light is viewed as a light in which (i) there is an equal amount of both orthogonal polarizations and (ii) the direction of the polarization at any given time is random and cannot be defined.

It is well known that unpolarized light can be identically viewed as composed of two orthogonal, circularly polarized lights (right-or left-handed) or of two orthogonal linearly polarized lights (x and y direction). In this application, for descriptive purposes, light is referred to as polarized in two directions to simplify the explanation of how the device works. It should be understood, however, that the devices and principles described herein will apply to all light. “Light” in this application may refer to visible light with a wavelength of about 380-750 nm, but light may in some cases also include near infrared radiation. In some cases, “light” may refer light having a wavelength range of 380-400 nm, 400-450 nm, 450-500 nm, 500-550 nm, 550-600 nm, 600-650 nm, 650-700 nm, 700-750 nm, 750-800 nm, 800-900 nm, 900-1000 nm, or any combination of ranges thereof.

As presented herein, the unpolarized light is considered to be composed of two linear polarizations in an x and a y direction and propagating in a z direction. Furthermore, it is noted that a reflective polarizer has also two axes, x and y (or P1 and P2) The reflective polarizer operates in a manner such that if the polarization axis of the light matches the axis of the reflective polarizer, then that polarization is predominantly reflected. If the polarization axis of the light is perpendicular to that of the reflective polarizer, then that component is predominantly transmitted.

It is noted that in the case of circular light, x and y (or P1 and P2) refer to the handedness of the polarization rather than fixed directions in space. Therefore x, for example, may denote right circular and y may denote left circular. As in the case of linearly polarized light, the unpolarized light will be considered to be composed of equal amounts of left and right circularly polarized amounts. The reflective polarizer, in that case, will reflect either the right-or the left-circular polarization depending on its configuration and will transmit the other polarization, left-or right-, respectively.

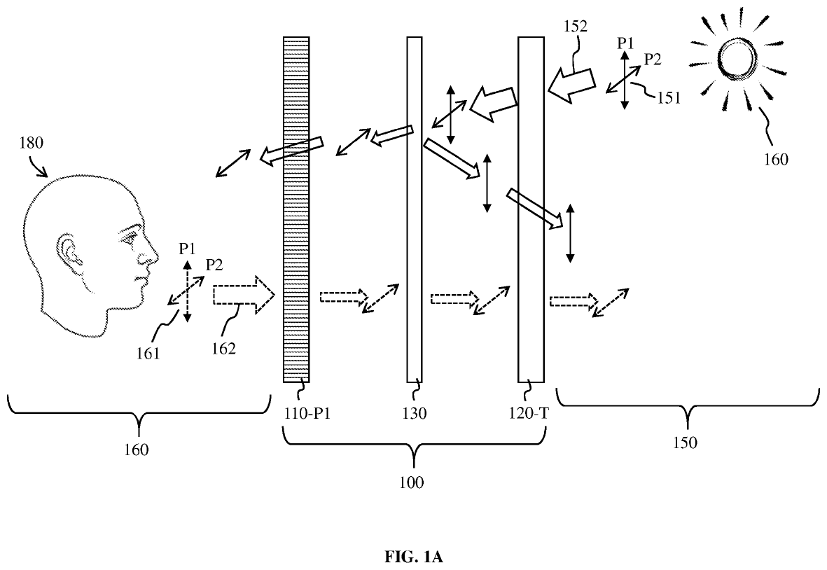

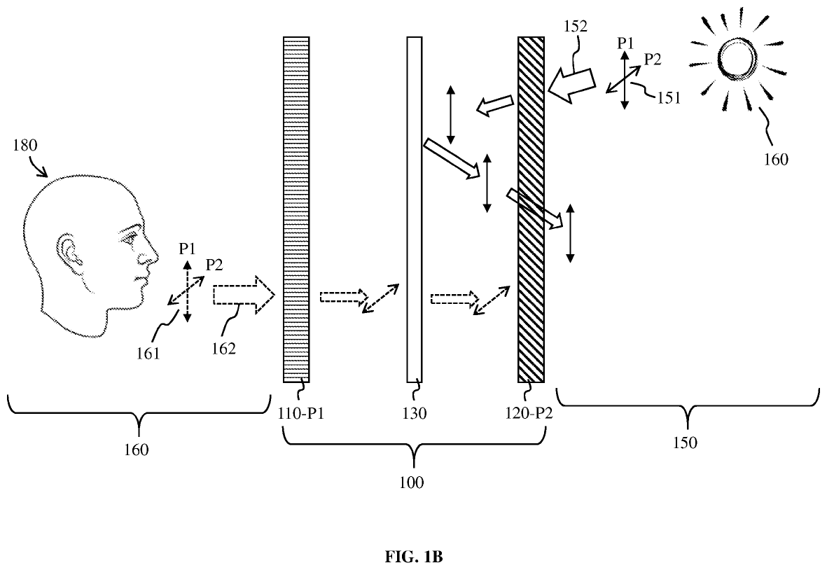

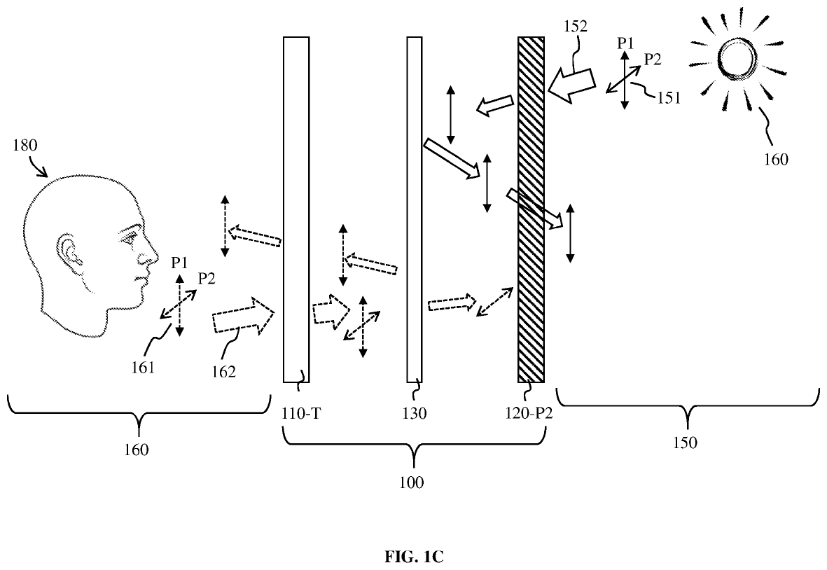

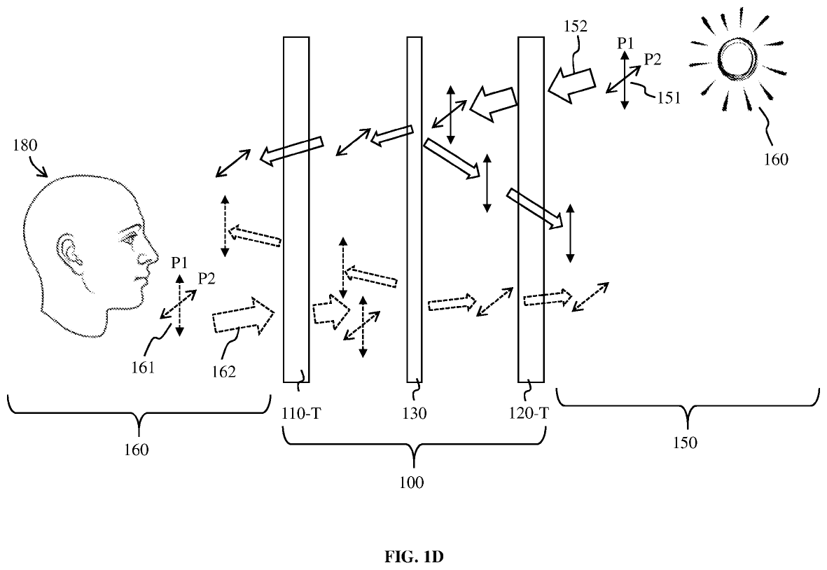

FIGS. 1A-1D are non-limiting examples of cross-sectional schematics of an electronic optical device in various device states according to some embodiments. Electronic optical device 100 includes a first active absorptive polarizer 110, a second active absorptive polarizer 120, and a static reflective polarizer 130 interposed between the first and second active absorptive polarizers. The first and second active absorptive polarizers may be independently controllable. For discussion purposes, the figures show the components as spaced apart, but in various embodiments, they may be laminated together. Although not shown, the electronic optical device 100 may in some cases be laminated or otherwise attached to a carrier or frame and form part of a system such as a window, a windshield, a sunroof, eyewear, a visor, a helmet, a lens, an AR display, a VR display, or some other suitable system.

The first active absorptive polarizer 110 can electronically alter absorption of a first polarization P1 of incident light, depending upon the applied voltage. A second polarization P2 of incident light, where polarization P2 is substantially orthogonal to P1, may be transmitted through the first active absorptive polarizer regardless of applied voltage, although there may be a small absorbance that is less intense than for P1 light. The second active absorptive polarizer 120 can electronically alter absorption of the second polarization P2 of light that may be incident on it, depending upon the applied voltage. Incident light of the first polarization P1 may substantially pass through the second active absorptive polarizer, regardless of voltage, although there may be a small absorbance that is less intense than for P2 light. The static reflective polarizer 130 substantially reflects polarization P1 light (e.g., at least 20%, 30%, 40%, 50%, 60%, 70%, 80%, or 90%) and substantially transmits polarization P2 light (e.g., at least 20%, 30%, 40%, 50%, 60%, 70%, 80%, or 90%). In some cases, with respect to polarization P1 light, static reflective polarizer 130 reflects 20-30%, 30-40%, 40-50%, 50-60%, 60-70%, 70-80%, 80-90%, 90-95%, 95-97%, 97-99%, or any combination of ranges thereof. In some cases, with respect to polarization P2 light, static reflective polarizer 130 transmits 20-30%, 30-40%, 40-50%, 50-60%, 60-70%, 70-80%, 80-90%, 90-95%, 95-97%, 97-99%, or any combination of ranges thereof.

In some cases, aside from differences in which polarization is absorbed, the light absorption envelopes or spectra of the first and second active absorptive polarizers may be substantially the same or they may be different. By “substantially the same” it is meant that the absorbance spectra in their respective high absorbance states match to within 15% across a range of 400-700 nm, or alternatively across a range of 400-1000 nm. For some applications, making the active absorptive polarizers substantially the same with respect to light absorption may provide the ability to produce a very dark device state, which may be desirable. However, some applications do not require matching absorption spectra. For example, one active absorptive polarizer may have a broadband (e.g., a neutral) absorption and the other may have a narrow band (e.g., a colored) absorption. In some preferred embodiments, there is at least some overlap between the absorption spectra for the first and second active absorptive polarizers. In some cases, one or both active absorptive polarizers may absorb some infrared radiation.

FIG. 1A shows electronic optical device 100 in transmissive device state. Here, the first active absorptive polarizer is in a high absorbance state (110-P1) and the second active absorptive polarizer is in a low absorbance state (120-T). A user 180 may be in a space 160 proximate the first active absorptive polarizer 110 and may wish to view through the device 100 to another space 150, for example, an outdoor environment that has bright light source 160 such as the sun. In a non-limiting example, the electronic optical device may be part of a car windshield system. Light from space 150, for example, sunlight 151 may be unpolarized, i.e., include light of both polarizations P1 and P2. Following the various arrows of light travel in FIG. 1A (generally right to left), both polarizations of incident light 152 on the second active absorptive polarizer may be substantially transmitted and reach the static reflective polarizer 130, which transmits P2 light and reflects P1 light back through the second active absorptive polarizer. The P2 light that reaches the first active absorptive polarizer is transmitted into space 160 and readily viewable by user 180.

Light 161 within space 160 (which may include sources other than light transmitted through the electronic optical device) may also be unpolarized and include both polarizations, P1 and P2. Following the various dashed arrows in FIG. 1A (generally left to right), the P1 component incident light 162 on the first active absorptive polarizer is substantially absorbed, but the P2 component may be substantially transmitted. The P2 component is also transmitted by the static reflective polarizer 130 and the second active absorptive polarizer 120. Thus, user 180 receives very little reflection from incident light 162 which creates a high-quality transmissive device state where the user can readily view space 150 in a manner that is not degraded by contrast-reducing (or distracting) reflections. In some embodiments, at least 10% of the P2 light incident on either active absorptive polarizer may be transmitted through the optical device, alternatively at least 20%, 30%, 40%, 50%, 60%, 70%, 80%, 90%. In some embodiments, the amount of P2 light incident on either active absorptive polarizer that is transmitted through the optical device 100 may be in a range of 20-30%, 30-40%, 40-50%, 50-60%, 60-70%, 70-80%, 80-90%, 90-95%, 95-97%, 97-99%, or any combination of ranges thereof. In some cases, there may be some asymmetry and relatively more of P2 light is transmitted from space 160 to space 150 than from space 150 to 160 (or vice versa).

FIG. 1B shows electronic optical device 100 in a dark device state. Here, the first and second active absorptive polarizers are in their high absorbance states (110-P1 and 120-P2, respectively). Following the various arrows in FIG. 1B (generally right to left), the P2 component of incident light 152 on the second active absorptive polarizer may be substantially absorbed whereas the P1 component may be transmitted, but it is then reflected of the static reflective polarizer 130 and back through the second active absorptive polarizer. Thus, relatively little light of either polarization from space 150 reaches observer 180.

Light 161 within space 160 may also include both polarizations, P1 and P2. Following the various dashed arrows in FIG. 1B (generally left to right), the P1 component of incident light 162 on the first active absorptive polarizer is substantially absorbed, but the P2 component may be substantially transmitted. The P2 component is also transmitted by the static reflective polarizer 130 and the second active absorptive polarizer 120. Thus, very little light of either polarization from space 160 reaches space 150. This may provide the user 180 with substantial privacy and a high-quality dark device state, e.g., to allow the user to rest or sleep. In some embodiments, less than 15% of light of either polarization incident on either active absorptive polarizer may be transmitted through the optical device, alternatively, less than 10%, 5%, 1%, 0.5%, 0.1%, 0.01% or even 0.001%. In some cases, when both active absorptive polarizers are in their high absorbance state, the amount of light of either polarization incident on either active absorptive polarizer that is transmitted through optical device 100 may be in a range of 0.0001-0.001%, 0.001-0.01%, 0.01-0.1%, 0.1-0.5%, 0.5%-1%, 1-5%, 5-10%, 10-15%, or any combination of ranges thereof.

FIG. 1C shows electronic optical device 100 in a reflective device state. Here the first active absorptive polarizer is in low absorbance state (110-T) and the second active absorptive polarizer is in a high absorbance state (120-P2). As described with respect to FIG. 1B, relatively little light of either polarization from space 150 reaches observer 180. Light 161 within space 160 may be unpolarized and include both polarizations, P1 and P2. Following the various dashed arrows in FIG. 1B (generally left to right), both the P1 and P2 components of incident light 162 on the first active absorptive polarizer may be transmitted. When that light reaches the static reflective polarizer 130, the P2 component may be substantially transmitted and then absorbed by the second active absorptive polarizer 120. However, the P1 component is reflected off the reflective polarizer and back through the first active absorptive polarizer to user 180. Thus, the user may use the device as a mirror and still maintain privacy. In some embodiments, at least 10% of P1 light incident on the first active absorptive polarizer is reflected to the user via the static reflective polarizer, alternatively at least 20%, 30%, 40%, 50%, 60%, 70%, 80%, or 90%. In some embodiments, when the device is in such a reflective device state, the amount of P1 light incident on the first active absorptive polarizer that is reflected back to the user via the static reflective polarizer may be in a range of 10-20%, 20-30%, 30-40%, 40-50%, 50-60%, 60-70%, 70-80%, 80-90%, 90-95%, 95-97%, 97-99%, or any combination of ranges thereof.

FIG. 1D shows electronic optical device 100 in a hybrid transmissive-reflective device state. Here, the first and second active absorptive polarizers are in their low absorbance states (110-T and 120-T, respectively). As already described above, some P2 light from space 150 reaches space 160 for the user to view a scene. Further, some P1 light from space 160 is reflected back to the user. If too much light is reflected, it may reduce the viewing quality of space 150. However, in some cases, this reflected light may be useful, e.g., when the electronic optical device is part system intended to reflect a projected image (e.g., a heads-up display on a windshield or an AR/VR eyewear device). In some cases, the projected image may itself be P1 polarized light so that it is reflected efficiently for the user, but also that relatively little may exit into space 150.

Although FIGS. 1A-1D have been described with respect to “low” and “high” absorbance states, in some embodiments, these active absorptive polarizers may have intermediate states that can be used to fine tune the user's experience.

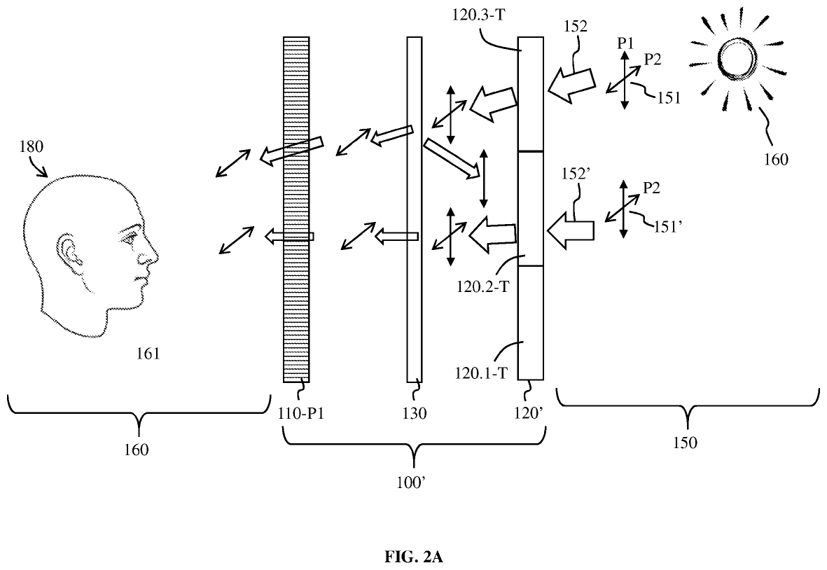

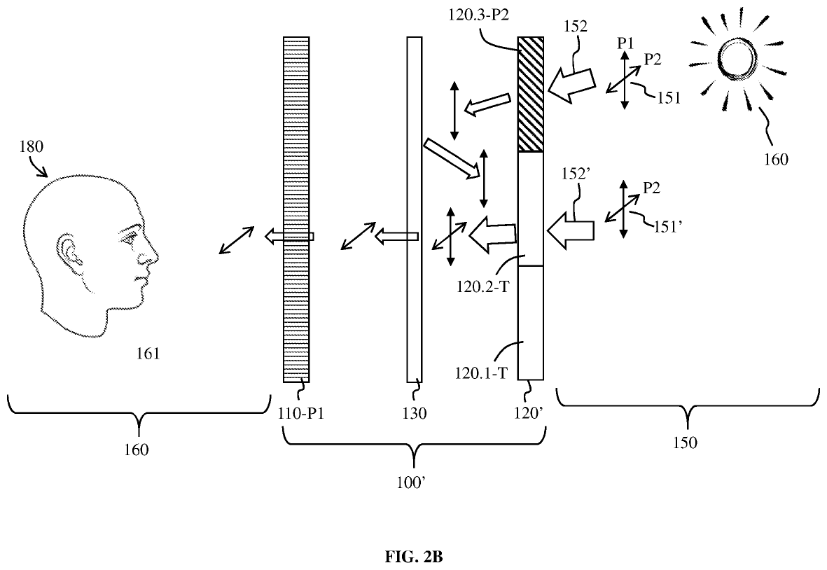

In some embodiments, one or both of the active absorptive polarizers may be patterned into individually addressable (controllable) segments or pixels. For example, FIGS. 2A and 2B are non-limiting examples of cross-sectional schematics of an electronic optical device in different device states according to some embodiments. FIG. 2A shows electronic optical device 100′ in a fully transmissive device state and is similar to FIG. 1A except that the second active absorptive polarizer 120′ has been patterned into various segment or portions. In this view, three segments 120.1-T, 120.2-T, and 120.3-T are all in the low absorbance state. The device may operate similarly as discussed with respect to FIG. 1A. In addition to unpolarized sunlight 151 that may be incident on the second active absorptive polarizer 120′, FIG. 2A also illustrates other unpolarized light 151′ in space 150 incident on the second active absorptive polarizer. The unpolarized light 151′ may be from an area that the user may wish to view (e.g., a roadway). P2 polarized light from 151 and 151′ may both reach the user 180. However, in some cases sunlight 151 (or some other bright light source) may be very distracting or dominating, and negatively impact the user's ability to see light 151′ from the area of interest very well.

In FIG. 2B, segment 120.3 has been switched to its high absorbance state (123.3-P2). Segment 120.3 may be in the direct path between the sunlight and the user's eyes. This portion of the optical device corresponding to segment 120.3 will operate similarly to FIG. 1B (dark device state) and strongly block the bright sunlight for the user, but still allow excellent viewing by the user through segments 120.1 and 120.3.

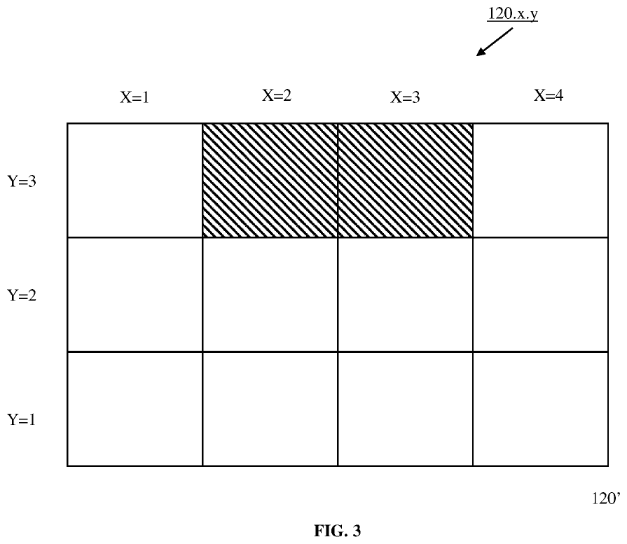

There are many possible configurations for segments and there is no particular limitation. FIG. 3 is a plan view of a non-limiting example of a patterned second active absorptive polarizer according to some embodiments. Second active absorptive polarizer 120′ may, for example, include 12 individually addressable segments: 10 in a low absorbance state (120.1.1, 120.1.2, 120.1.3, 120.2.1, 120.2.2, 120.3.1, 120.3.2, 120.4.1, 120.4.2, 120.4.3) and 2 segments in a high absorbance state (120.2.3, 120.3.3). FIG. 2B may even represent a cross section down the X=3 row of FIG. 3. The size and location(s) of the dark device portions may be selectable by a user, automatically selected, or even a combination. If this was a car windshield, a second user (such as passenger) may be able to select as well. In some cases, the electronic optical device may be in communication with one or more sensors (light sensor, eye-location sensor, etc.) that may determine in part which segments to be adjusted. In some cases, rather than bright sun, the bright object may be a distracting reflection, a vehicle with bright headlights, or even a hostile laser intended to dazzle the user.

Although shown as having a uniform size and shape, the segments may have different sizes or shapes. For example, rather than square or rectangular, a segment may be triangular, pentagonal, hexagonal, or some other shape. In some cases, the size of a segment may be described by its longest axis, e.g., in the case of FIG. 3, a diagonal from corner to corner. The size of the segment depends in part on the nature of the device or system with which it is used. In some embodiments, segments may have a longest axis in a range of 0.1-0.2 cm, 0.2-0.4 cm, 0.6-0.8 cm, 0.8-1.0 cm, 1.0-1.5 cm, 1.5-2.0 cm,, 2-3 cm, 3-5 cm, 5-7 cm, 7-10 cm, 10-15 cm, 15-20 cm, 20-30 cm, 30-40 cm, 40-50 cm, 50-70 cm, 70 cm-1 m, 1-1.5 m, 1.5 m-2 m, 2-3 m, or any combination of ranges thereof, or in some cases, even greater than 3 m or less than 0.1 cm. For eyewear, visors and helmets, the segment size may be on the lower end of these ranges, whereas car and building windows, the segment size may be at the higher end of these ranges. In some cases, the size of segments may be defined relative to the length or width of the system (e.g., window, a windshield, a sunroof, eyewear, a visor, a helmet, an AR headset, or the like) with which the optical device is being used. For example, in some cases, the optical device may include 2-3 segments across its length or width, alternatively, 3-4, 4-5, 5-10, 10-20, 20-50, 50-100, or any combination of ranges thereof, or in some cases, even greater than 100.

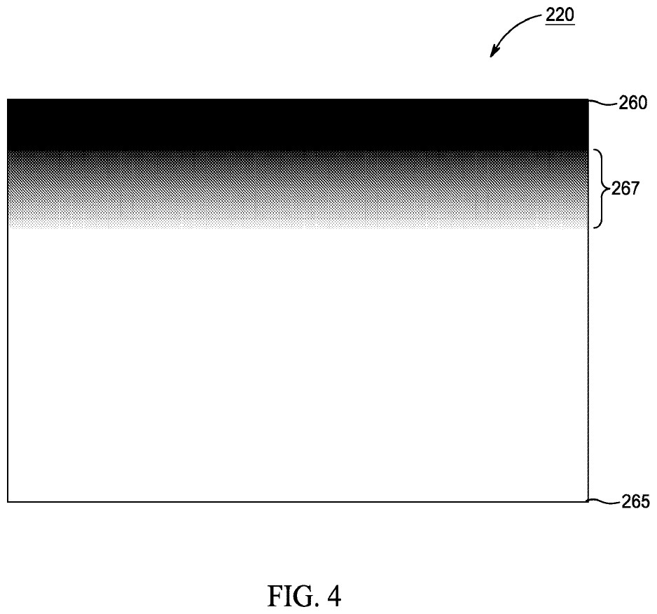

Instead of using segmenting or patterning, the second active absorptive polarizer may be a graduated electrooptical device, e.g., as described in PCT publication WO2022047371, filed Aug. 31, 2021, the entire contents of which is incorporated herein by reference for all purposes. FIG. 4 is a plan view of a non-limiting example of a graduated active absorptive polarizer according to some embodiments. For example, graduated active absorptive polarizer 220 may correspond to the second active absorptive polarizer in the electronic optical device. Using graduated electrooptical technology, a high absorbance state may be formed, e.g., near one end 260 of the active absorptive polarizer, and a low absorption state may be formed at the opposite end 265. A graduated transition from high to low absorption may occur over zone 267.

Although not shown, the first active absorptive polarizer may instead (or also) be patterned into individually addressable segments or pixels, or be a graduated electrooptic device. For example, and with reference again to FIGS. 1A-2B , there may be positions on the electronic optical device where a user may desire good reflection from light within space 160 (e.g., from a heads-up display), and other areas where they want limited reflection for good viewing into space 150.

In the devices described herein, a switchable polarizer can in some embodiments be provided by a using a Guest-Host system: dichroic dye moieties in association with a nematic or chiral nematic liquid crystal (LC) material layer. For example, the dichroic dye moieties may be mixed with, dissolved in, or even covalently attached to the LC. In some embodiments, dye molecules (Guest) are oriented by the presence of the LC molecules (Host). Applying an electric field to the layer will re-orient the LC molecules and the dye molecules will follow this re-orientation. Such a stack will either absorb light of one polarization or be transparent. Suitable dyes that can be added to liquid crystal mixtures for this purpose are known in the art. The degree of preferential absorption of one polarization with respect to the other is dependent on the applied voltage.

The absorptive polarizer of the present invention is assumed to be active in that its polarizing/absorptive properties can be altered by application of an external electrical field (voltage). Furthermore, this active polarizer is based on a guest-host liquid crystal system or cell that includes a negative dielectric anisotropy host combined with a positive dichroic dye in a homeotropically aligned cell. Alternatively, a positive dielectric anisotropy host can be used with positive dichroic dyes in a planar aligned cell. The liquid crystal cell may be designed such that application of a voltage results in a change in transmission of the light through the cell. For example, application of low or no voltage may put the active absorptive polarizer in a high absorbance state, whereas application of a higher voltage may put the active absorptive polarizer in a low absorbance state. Alternatively, the LC cell may be designed such that application of low or no voltage may put the active absorptive polarizer in a low absorbance state, whereas application of a higher voltage may put the active absorptive polarizer in a high absorbance state.

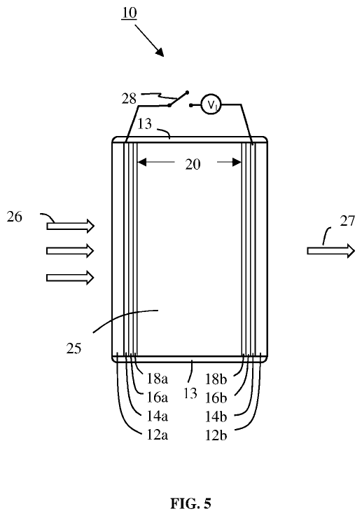

FIG. 5 is a cross-sectional view of a non-limiting example of an active absorptive polarizer according to some embodiments. Incident light 26 is at least partially absorbed by active absorptive polarizer 10 which passes through as transmitted (attenuated) polarized light 27.

Active absorptive polarizer 10 may include a pair of substrates, 12a, 12b. As discussed in more detail later, the substrates may be independently selected and include, for example, a polymeric material, a glass, or a ceramic. A pair of transparent conducting layers, 14a, 14b may be provided or coated over each respective substrate surface interior to the cell. In some embodiments, an optional passivation layer (which in some cases may be referred to as an insulating layer or “hard coat”), 16a, 16b, may be provided over the respective transparent conducting layer. The passivation layer may include, for example, a non-conductive oxide, sol-gel, polymer, or a composite. An optional alignment layer 18a, 18b, may be provided over the passivation layer or the transparent conducting layer. As a non-limiting example, the alignment layer may include polyimide. In some embodiments, the alignment layer may function as a passivation layer. In some embodiments, the alignment layer may be rubbed as is known in the art to assist in orienting the electro-optic material, e.g., a LC host, near the surface. In some embodiments, both alignment layers of a cell are rubbed. In some embodiments, a cell may include only one brushed alignment layer.

Active absorptive polarizer 10 includes electro-optic material 25 provided between the substrates. In the case of an active absorptive polarizer, the electro-optic material may be capable of changing from a state of lower light transmittance to a state of higher light transmittance for a particular wavelength region (and polarization) upon a change in an electric field applied across the electro-optic material. The electric field may be changed, for example, by changing the voltage applied between the pair of transparent conductive layers 14a, 14b. In some embodiments, the electro-optic material is a liquid crystal guest-host (“LC-GH”) material. As shown in FIG. 5, in some embodiments, the LC-GH material may be in its most light absorbing state (dark state) when no voltage is applied. In some cases, an active absorptive polarizer having a high absorbance state at V=0 may in some cases be provided by using an LC host having positive anisotropy. Conversely, an LC host having negative anisotropy may be used to produce an active absorptive polarizer that is relatively clear (low absorbance state) at V=0.

The substrates and any overlying layers define a cell gap 20 (“d”). In some embodiments (not shown), the cell may include spacer beads or other structures to maintain the gap. In some cases, the cell structure may be enclosed by sealing material 13 such as a UV-cured optical adhesive or other sealants known in the art.

The conducting layers may be electrically connected to a variable voltage supply which are represented schematically by the encircled V₁. FIG. 5 shows the cell power circuit with its switch 28 open so that no voltage is applied and the active absorptive polarizer is in its dark state. When switch 28 is closed, a variable voltage or electric field may be applied across liquid crystal guest-host material 25.

### Electro-Optic Material

An electro-optic material is one capable of changing its light absorption profile upon application of an electric field. In some embodiments, the electro-optic material may include a guest-host system having an LC host and a DC dye dissolved or dispersed therein, or alternatively a dichroic light absorbing moiety covalently attached to the LC host (all considered a guest-host mixture). Whether dissolved, dispersed, or attached, such a composition may be referred to as an LC-GH material or mixture.

In some embodiments, a liquid crystal guest-host includes a mixture of a cholesteric or chiral nematic liquid crystal host and a dyestuff material. The dyestuff material may be characterized as having dichroic properties, and as described below, may include a single dye or a mixture of dyes (DC light absorbing moieties) to provide these properties. In some embodiments, the liquid crystal guest-host mixture may be formulated as a “narrow band mixture” to produce a color absorptive polarizer or alternatively as a “wide band mixture” to produce a generally neutral absorptive polarizer. Note that the term “mixture” in the context of guest-host materials is generally used broadly herein, and may refer to a DC moiety covalently attached to the LC host. A guest-host mixture may be, but is not necessarily, a simple combination of separate dye and liquid crystal molecules.

### LC Host

In some embodiments, the host includes a chiral nematic or cholesteric liquid crystal material (including some twisted nematic LC's) (collectively “CLC”) which may have a negative dielectric anisotropy (“negative CLC”) or a positive dielectric anisotropy (“positive CLC”). In some embodiments of the CLC, the liquid crystal material is cholesteric, or it includes a nematic liquid crystal in combination with a chiral dopant. A CLC material has a twisted or helical structure. The periodicity of the twist is referred to as its “pitch” (“p”). The orientation or order of the liquid crystal host may be changed upon application of an electric field, and in combination with the dyestuff material, may be used to control or partially control the optical properties of the active absorptive polarizer. In some embodiments, the CLC may be further characterized by its chirality, i.e., right-handed chirality or left-handed chirality.

### Dyestuff Material

To provide dichroic properties, the dyestuff material generally includes at least one dichroic (DC) dye or mixture of DC dyes (DC light-absorbing moieties).

In some embodiments, the dyestuff material may further include a small amount of a conventional absorbing dye, e.g., to provide the device with a desired overall hue in the clear state. In some embodiments, the dyestuff material includes substantially only DC dyes.

### DC Dyes

Dichroic dyes typically have an elongated molecular shape and exhibit anisotropic absorption. Commonly, the absorption is higher along the long axis of the molecule and such dyes may be referred to as “positive dyes” or dyes exhibiting positive dichroism. Positive DC dyes are generally used herein. However, in some cases, negative DC dyes that exhibit negative dichroism may be used instead. In some embodiments, a DC dye (as measured in a CLC host) may have a dichroic ratio of at least 5.0, alternatively at least 6, 7, 8, 9, 10, 11, 12, 13, 14, 15, 16, 17, 18, 19 or 20.

The level of visible light absorption by the DC dye may be a function of the dye type and the CLC host. For active absorptive polarizers of the present disclosure, the apparent absorption of visible light may also be a function of voltage. The orientation or long-range order of the CLC may be a function of electric field or voltage across the cell thickness. A DC dye exhibits some alignment with the CLC host so that application of a voltage may be used to alter the apparent darkness of the cell.

In some embodiments, a DC dye may include a small molecule type of material (organic, inorganic, organometallic, organic complexes of a metal, or the like). In some embodiments, a DC dye may include an oligomeric or polymeric material. The chemical moiety responsible for light absorption may, for example, be a pendent group on a main chain. Multiple DC dyes may optionally be used, for example, to tune the light absorption envelope or to improve overall cell performance with respect to lifetime or some other property. DC dyes may include functional groups that may improve solubility, miscibility with or bonding to the CLC host. Some non-limiting examples of DC dyes may include azo dyes, for example, azo dyes having 2 to 10 azo groups, or alternatively, 2 to 6 azo groups. Other DC dyes are known in the art, such as anthraquinone and perylene dyes. Generally, any molecule with dichroic properties can be used.

In some embodiments, a guest-host mixture has a nematic-isotropic transition temperature TNI greater than 40° C. In other embodiments, the TNI is greater than 45° C., 50° C., 55° C., 60° C., 65° C., 70° C., 75° C., 80° C., 85° C. or 90° C.

In some embodiments, the active absorptive polarizer includes a guest-host mixture with an order parameter, Sₘᵢₓ, greater than or equal to 0.60, 0.65, 0.7, 0.71, 0.72, 0.73, 0.74, 0.75, 0.76, 0.77 or 0.78, 0.79, 0.80, 0.81, 0.82, 0.83, 0.84, or 0.85.

In some embodiments, an active absorptive polarizer of the present disclosure may use a guest-host mixture that may be described as “chiral planar”.

### Other Cell Features

### Substrate

Referring again to FIG. 5, in some embodiments, the substrate 12a, 12b, may be independently selected and may include one or both flexible substrates or non-flexible ceramic or glass. Flexible substrates may include: a plastic, a flexible glass, or some other material. Choice of material and its particular properties depends in part on the intended application. The substrate should be at least partially transmissive to visible light.

In some embodiments, the substrate may have low optical haze below 10%, (or in some embodiments below 9%, 8%, 7%, 6%, 5%, 4%, 3%, 2% or 1%), so that a person or sensor may clearly see through the active absorptive polarizer 10 when so desired. In some embodiments, the substrate may optionally have some color or tint. In some embodiments, the substrate may have an optical coating on the outside of the cell. A substrate may be flexible or rigid.

As some non-limiting examples, a plastic substrate may include a polycarbonate (PC), a polycarbonate and copolymer blend, a polyethersulfone (PES), a polyethylene terephthalate (PET), cellulose triacetate (TAC), a polyamide, p-nitrophenylbutyrate (PNB), a polyetheretherketone (PEEK), a polyethylenenapthalate (PEN), a polyetherimide (PEI), polyarylate (PAR), a polyvinyl acetate, a cyclic olefin polymer (COP) or other similar plastics known in the art. In some non-limiting examples, flexible glass including materials such as Corning® Willow® Glass and the like can be used as a substrate. A substrate may include multiple materials or have a multi-layer structure. In some embodiments, an active absorptive polarizer may use plastic substrates that have an optical retardation with less than ±20% variation in uniformity across the area of the device, alternatively less than ±15%, or less than ±10%.

In some embodiments, the thickness of a substrate may be in a range of 10-50 μm, 50-100 μm, 100-150 μm, 150-200 μm, 200-250 μm, 250-300 μm, 300-350 μm, 350-400 μm, 400-450 μm, 450-500 μm, 500-600 μm, 600-800 μm, 800-1000 μm, 1-2 mm, 2-3 mm, 3-4 mm, 4-5 mm, or greater than 5 mm or any combination of ranges thereof.

### Transparent conducting layer

A “transparent” conducting layer refers to a conducting layer 14a, 14b that generally allows at least 45% of incident visible light to pass through. A transparent conducting layer may absorb or reflect a portion of visible light and still be useful. In some embodiments, the transparent conducting layer may include a transparent conducting oxide (TCO) including, but not limited to, ITO or AZO. In some embodiments, the transparent conducting layer may include a conductive polymer including, but not limited to, PEDOT: PSS, a poly(pyrrole), a polyaniline, a polyphenylene, or a poly(acetylene). In some embodiments, the transparent conducting layer may include a partially transparent thin layer of metal or metal nanowires, e.g., formed of silver, copper, aluminum, or gold. In some embodiments, the transparent conducting layer may include graphene.

### Enumerated Embodiments

Still further embodiments herein include the following enumerated embodiments.

1. An electronic optical device including:
a first active absorptive polarizer that electronically alters absorption of a first polarization of light depending on an applied first voltage;
a second active absorptive polarizer that electronically alters absorption of a second polarization of light depending on an applied second voltage, wherein the second polarization is substantially orthogonal to the first polarization; and
a static reflective polarizer interposed between the first active absorptive polarizer and the second active absorptive polarizer, wherein the static reflective polarizer reflects the first polarization of light.

2. The device of embodiment 1, wherein the device is configurable to provide a transmissive device state, wherein the first active absorptive polarizer is in a high absorbance state and the second active absorptive polarizer is in a low absorbance state, such that at least 10% of light of the second polarization incident on either active absorptive polarizer is transmitted through the device.

3. The device of embodiment 1 or 2, wherein the device is configurable to provide a dark device state, wherein the first active absorptive polarizer is in a high absorbance state and the second active absorptive polarizer is in a high absorbance state, such that less than 15% of light of either polarization incident on either active absorptive polarizer is transmitted through the device.

4. The device according to any of embodiments 1-3, wherein the device is configurable to provide a reflective device state, wherein the first active absorptive polarizer is in a low absorbance state and the second active absorptive polarizer is in a high absorbance state, such that i) at least 10% of light of the first polarization incident on the first active absorptive polarizer is reflected via the static reflective polarizer, and ii) less than 15% of light of either polarization incident on the second active absorptive polarizer is transmitted through the device.

5. The device according to any of embodiments 1-4, wherein the device is configurable to provide a hybrid transmissive-reflective device state, wherein the first active absorptive polarizer is in a low absorbance state and the second active absorptive polarizer is in a low absorbance state, such that i) at least 10% of light of the first polarization incident on the first active absorptive polarizer is reflected, and ii) at least 10% of light of the second polarization incident on either active absorptive polarizer is transmitted through the device.

6 The device according to any of embodiments 1-5, wherein when the device is in use, a device user is positioned proximate the first active absorptive polarizer.

7. The device according to any of embodiments 1-6, wherein the second active absorptive polarizer includes individually addressable segments or pixels.

8. The device of embodiment 7, wherein at least one portion of the optical device is configured to provide one device state, and at least one other portion of the optical device is configured to provide another device state.

9. The device of embodiment 8, wherein the at least one portion corresponds to a dark device state and the at least one other portion corresponds to a transmissive state.

10. The device according to any of embodiments 7-9, wherein a size and location of the at least one portion is selectable by a user.

11. The device according to any of embodiments 7-10, wherein a size and location of the at least one portion is automatically selected.

12. The device of embodiment 11, wherein the automatic selection is based in part on a location of a user's eye relative to a source of bright light.

13. The device according to any of embodiments 1-12, wherein the first active absorptive polarizer is in a state of high absorbance when the applied first voltage is low or off.

14. The device according to any of embodiments 1-12, wherein the first active absorptive polarizer is in a state of low absorbance when the applied first voltage is low or off.

15. The device according to any of embodiments 1-14, wherein the second active absorptive polarizer is in a state of high absorbance when the applied second voltage is low or off.

16. The device according to any of embodiments 1-14, wherein the second active absorptive polarizer is in a state of low absorbance when the applied second voltage is low or off.

17. The device according to any of embodiments 1-16, where at least one active absorptive polarizer includes an electro-optic material including a dichroic light-absorber and a liquid crystal host.

18. The device of embodiment 17, wherein the dichroic light-absorber includes a dichroic dye moiety covalently attached to the liquid crystal host.

19. The device of embodiment 17 or 18, wherein the dichroic light-absorbing moiety includes a molecular dichroic dye mixed with the liquid crystal host.

20. The device according to any of embodiments 1-19, wherein the first active absorptive polarizer is characterized by a first light absorption spectrum, and wherein the second active absorptive polarizer is characterized by a second light absorption spectrum.

21. The device of embodiment 20, wherein the first light absorption spectrum includes a wide band absorption profile when measured in a range of 400-1000 nm.

22. The device of embodiment 20, wherein the first light absorption spectrum includes a narrow band absorption profile when measured in a range of 400-1000 nm.

23. The device according to any of embodiments 20-22, wherein the second light absorption spectrum includes a wide band absorption profile when measured in a range of 400-1000 nm.

24. The device according to any of embodiments 20-22, wherein the second light absorption spectrum includes a narrow band absorption profile when measured in a range of 400-1000 nm.

25. The device according to any of embodiments 20-24, wherein the first light absorption spectrum is substantially the same as the second light absorption spectrum when measured in a range of 400-1000 nm.

26. The device according to any of embodiments 1-25, wherein at least one active absorptive polarizer is a graduated electrooptic device.

27. A system including the electronic optical device according to any of embodiments 1-26, wherein the system is a window, a windshield, a sunroof, eyewear, a visor, a helmet, a lens, an AR display, or a VR display.

28. A method of altering the transmission of light using a device according to any of embodiments 1-26, the method including controlling a voltage applied across the first and second active absorptive polarizers to provide a transmissive device state, a dark device state, a reflective device state, or a hybrid transmissive-reflective device state.

29. The method of embodiment 28, wherein at least one active absorptive polarizer includes individually addressable segments, the method further including selectively blocking a bright light source from a device user's eyes.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of example embodiments of the invention has been presented for the purposes of illustration and description. It is not intended to be exhaustive or to limit the invention to the precise form described, and many modifications and variations are possible in light of the teaching above.

In the preceding description, for the purposes of explanation, numerous details have been set forth in order to provide an understanding of various embodiments of the present technology. It will be apparent to one skilled in the art, however, that certain embodiments may be practiced without some of these details, or with additional details.

Having described several embodiments, it will be recognized by those of skill in the art that various modifications, alternative constructions, and equivalents may be used without departing from the spirit of the invention. Additionally, a number of well-known processes and elements have not been described in order to avoid unnecessarily obscuring the present invention. Additionally, details of any specific embodiment may not always be present in variations of that embodiment or may be added to other embodiments.

As used herein, a phrase that recites a range of values is inclusive of the end values, for example, “between X and Y,” “range of X to Y,” “from X to Y,” includes X and Y, or the phrase “up to Y” includes Y. Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither, or both limits are included in the smaller ranges is also encompassed within the invention, subject to any specifically excluded limit in the stated range. Where the stated range includes one or both of the limits, ranges excluding either or both of those included limits are also included.

As used herein and in the appended claims, the singular forms “a”, “an”, and “the” include plural referents unless the context clearly dictates otherwise. Thus, for example, reference to “a method” includes a plurality of such methods and reference to “the layer” includes reference to one or more layers and equivalents thereof known to those skilled in the art, and so forth. The invention has now been described in detail for the purposes of clarity and understanding. However, it will be appreciated that certain changes and modifications may be practiced within the scope of the appended claims.

All publications, patents, and patent applications cited herein are hereby incorporated by reference in their entirety for all purposes. None is admitted to be prior art.

### LISTING OF REFERENCE NUMERALS IN FIGURES

10—active absorptive polarizer
12a, 12b—substrate
13—sealing material
14a, 14b—transparent conducting layer
16a, 16b—passivation layer
18a, 18b—alignment layer
20—cell gap
25—electro-optic material
26—incident light
27—transmitted polarized light
28—switch
P1—first polarization of light
P2—second polarization of light
100—electronic optical device
110—first active absorptive polarizer
120—second active absorptive polarizer
120′—segmented second active absorptive polarizer
120.1, 120.2, 120.3, 120.x.y—segments of second active absorptive polarizer (where x=1-4 and y=1-3)
130—static reflective polarizer
150—space
151, 151′—light in space 150
152, 152′—incident light on second active absorptive polarizer
160—space
161—light in space 160
162—incident light on first active absorptive polarizer
180—user
220—graduated active absorptive polarizer
260—one end of graduated active absorptive polarizer
265—opposite end of graduated active absorptive polarizer
270—zone of graduated transition

1. An electronic optical device comprising:
a first active absorptive polarizer that electronically alters absorption of a first polarization of light depending on an applied first voltage;
a second active absorptive polarizer that electronically alters absorption of a second polarization of light depending on an applied second voltage, wherein the second polarization is substantially orthogonal to the first polarization; and
a static reflective polarizer interposed between the first active absorptive polarizer and the second active absorptive polarizer, wherein the static reflective polarizer reflects the first polarization of light.

2. The device of claim 1, wherein the device is configurable to provide a transmissive device state, wherein the first active absorptive polarizer is in a high absorbance state and the second active absorptive polarizer is in a low absorbance state, such that at least 10% of light of the second polarization incident on either active absorptive polarizer is transmitted through the device.

3. The device of claim 1, wherein the device is configurable to provide a dark device state, wherein the first active absorptive polarizer is in a high absorbance state and the second active absorptive polarizer is in a high absorbance state, such that less than 15% of light of either polarization incident on either active absorptive polarizer is transmitted through the device.

4. The device of claim 1, wherein the device is configurable to provide a reflective device state, wherein the first active absorptive polarizer is in a low absorbance state and the second active absorptive polarizer is in a high absorbance state, such that i) at least 10% of light of the first polarization incident on the first active absorptive polarizer is reflected via the static reflective polarizer, and ii) less than 15% of light of either polarization incident on the second active absorptive polarizer is transmitted through the device.

5. The device of claim 1, wherein the device is configurable to provide a hybrid transmissive-reflective device state, wherein the first active absorptive polarizer is in a low absorbance state and the second active absorptive polarizer is in a low absorbance state, such that i) at least 10% of light of the first polarization incident on the first active absorptive polarizer is reflected, and ii) at least 10% of light of the second polarization incident on either active absorptive polarizer is transmitted through the device.

6. The device of claim 1, wherein when the device is in use, a device user is positioned proximate the first active absorptive polarizer.

7. The device of claim 1, wherein the second active absorptive polarizer comprises individually addressable segments.

8. The device of claim 7, wherein at least one portion of the device is configured to provide one device state, and at least one other portion of the device is configured to provide another device state.

9. The device of claim 8, wherein the at least one portion corresponds to a dark device state and the at least one other portion corresponds to a transmissive state.

10. The device of claim 8, wherein a size and location of the at least one portion is selectable by a user.

11. The device of claim 8, wherein a size and location of the at least one portion is automatically selected.

12. The device of claim 11, wherein the automatic selection is based in part on a location of a user's eye relative to a source of bright light.

13. The device of claim 1, wherein the first active absorptive polarizer is in a state of high absorbance when the applied first voltage is low or off.

14. The device of claim 1, wherein the first active absorptive polarizer is in a state of low absorbance when the applied first voltage is low or off.

15. The device of claim 1, wherein the second active absorptive polarizer is in a state of high absorbance when the applied second voltage is low or off.

16. The device of claim 1, wherein the second active absorptive polarizer is in a state of low absorbance when the applied second voltage is low or off.

17. The device of claim 1, where at least one active absorptive polarizer includes an electro-optic material comprising a dichroic light-absorber and a liquid crystal host.

18. The device of claim 17, wherein the dichroic light-absorber comprises a dichroic dye moiety covalently attached to the liquid crystal host.

19. The device of claim 17, wherein the dichroic light-absorber comprises a molecular dichroic dye mixed with the liquid crystal host.

20. The device of claim 1, wherein the first active absorptive polarizer is characterized by a first light absorption spectrum, and wherein the second active absorptive polarizer is characterized by a second light absorption spectrum.

21. The device of claim 20, wherein the first light absorption spectrum comprises a wide band absorption profile when measured in a range of 400-1000 nm.

22. The device of claim 20, wherein the first light absorption spectrum comprises a narrow band absorption profile when measured in a range of 400-1000 nm.

23. The device of claim 20, wherein the second light absorption spectrum comprises a wide band absorption profile when measured in a range of 400-1000 nm.

24. The device of claim 20, wherein the second light absorption spectrum comprises a narrow band absorption profile when measured in a range of 400-1000 nm.

25. The device of claim 20, wherein the first light absorption spectrum is substantially the same as the second light absorption spectrum when measured in a range of 400-1000 nm.

26. The device of claim 1, wherein at least one active absorptive polarizer is a graduated electrooptic device.

27. A system comprising the electronic optical device of claim 1, wherein the system is a window, a windshield, a sunroof, eyewear, a visor, a helmet, a lens, an AR display, or a VR display.

28. A method of altering transmission of light through the device of claim 1, the method comprising controlling a voltage applied across the first and second active absorptive polarizers to provide a transmissive device state, a dark device state, a reflective device state, or a hybrid transmissive-reflective device state.

29. The method of claim 28, wherein at least one active absorptive polarizer comprises individually addressable segments, the method further comprising selectively blocking a bright light source from a device user's eyes.
